(19) United States
(12) Patent Application Publication
(10) Pub. No.: US 2013/0038045 A1
(43) Pub. Date: Feb. 14, 2013

(54) WIRELESS AIRBAG APPARATUS

(71) Applicants: Hyock In KWON, Seongnam-si (KR); Dae Young Kwak, Yongin-si (KR); Jae Geun Oh, Hwaseong-si (KR); Jae Yun Lee, Yongin-si (KR)

(72) Inventors: Hyock In KWON, Seongnam-si (KR); Dae Young Kwak, Yongin-si (KR); Jae Geun Oh, Hwaseong-si (KR); Jae Yun Lee, Yongin-si (KR)

(73) Assignee: Hyundai Motor Company, Seoul (KR)

(21) Appl. No.: 13/303,587

(22) Filed: Nov. 23, 2011

(30) Foreign Application Priority Data
Aug. 10, 2011 (KR) 10-2011-0079764

(51) Int. Cl. B60R 21/16

(52) U.S. Cl. 280/735

(57) ABSTRACT

A wireless airbag apparatus may include an airbag control unit (ACU) receiving a sensing signal from a collision sensor and having a first wireless communication unit, and an airbag module having a second wireless communication unit and a power supply circuit to transceive a signal with the wireless communication unit of the ACU, wherein the power supply circuit supplies operating power to an inflator in accordance with a deployment signal of the airbag module.

### CROSS-REFERENCE TO RELATED APPLICATION

The present application claims priority to Korean Patent Application No. 10-2011-0079764, filed on Aug. 10, 2011, the entire contents of which is incorporated herein for all purposes by this reference.

### BACKGROUND OF THE INVENTION

1. Field of the Invention

The present invention relates generally to a wireless airbag apparatus configured to transceive a signal between an airbag control unit (hereinafter referred to as an ACU) and an airbag module using wireless communication and, more particularly, to a wireless airbag apparatus configured so that an airbag module can self-charge power required to deploy an airbag using a small self-power generator.

2. Description of Related Art

Generally, a vehicle is provided with several kinds of airbag apparatuses to protect the safety of a passenger. As shown in FIG. 1, a conventional airbag apparatus is configured so that an ACU 1 and an airbag module 2 are connected to each other by a wire 3.

When the ACU 1 receives a signal from a collision sensor 4, the ACU 1 transmits an airbag deployment signal to the airbag module 2 and transmits a current to deploy an airbag. The airbag module 2 transmitting an airbag connection signal to the ACU 1 includes an inflator 2a and an airbag cushion 2b.

However, the conventional airbag apparatus is problematic in that the use of the wire 3 causes problems during assembly and packaging and causes the airbag to malfunction and a warning light to go off because of a contact failure, and different wires are required for different kinds of airbags, so that the airbag apparatus cannot be applied in the same manner to different kinds of airbags.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a wireless airbag apparatus, which is configured so that an ACU and an airbag module can transceive a signal using wireless communication, and the airbag module can self-charge power required to deploy an airbag using a small self-power generator.

In an aspect of the present invention, the wireless airbag apparatus may include an airbag control unit (ACU) receiving a sensing signal from a collision sensor and having a first wireless communication unit, and an airbag module having a second wireless communication unit and a power supply circuit to transceive a signal with the wireless communication unit of the ACU, wherein the power supply circuit supplies operating power to an inflator in accordance with a deployment signal of the airbag module.

The power supply circuit may include the second wireless communication unit generating the deployment signal for the inflator to deploy an airbag cushion, a CPU generating a deployment command for the inflator in response to the deployment signal of the second wireless communication unit, a capacitor accumulating power required to operate the inflator and to supply the power to the CPU, a regulator regulating voltage to deploy the airbag cushion in response to the deployment command of the CPU, and an ignition circuit receiving a regulated voltage of the regulator and transmitting an ignition signal to the inflator.

The power accumulated in the capacitor is produced using surplus energy generated from a vehicle by a self-power generator, wherein the self-power generator is may include d in the power supply circuit.

The power accumulated in the capacitor is wirelessly transmitted from an external power source.

The inflator and the ignition circuit are connected to each other via a squib connector.

The first wireless communication unit of the ACU and the second wireless communication unit of the airbag module may include a transmitting part and a receiving part respectively, wherein the transmitting part of the airbag module transmits a connection signal and a deployment record of the airbag cushion to the receiving part of the ACU.

The wireless airbag apparatus according to the present invention is advantageous in that an ACU and an airbag module are configured to transceive a signal using wireless communication, so that a wire is not used, thus solving problems occurring during assembly and packaging, preventing an airbag from malfunctioning and preventing a warning light from going off because of a contact failure, and allowing the airbag apparatus to be used in a common manner among different kinds of airbags regardless of their type. Further, the wireless airbag apparatus according to the present invention is advantageous in that a small self-power generator using energy harvesting technology produces electricity used to deploy an airbag, so that the electricity that deploys the airbag can be produced semi-permanently without requiring an additional external power supply.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a conventional airbag apparatus using a wire.

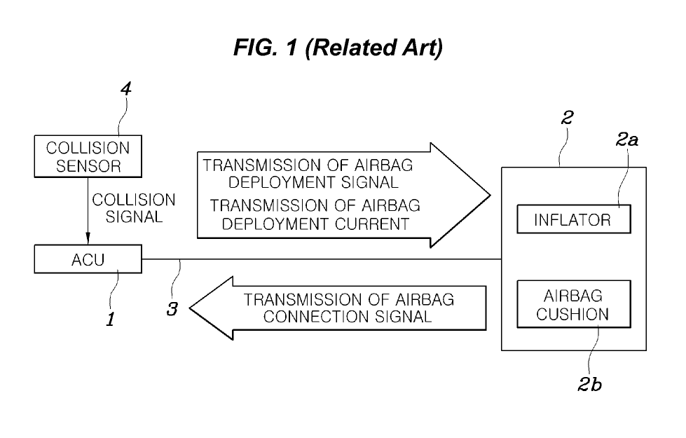

FIG. 2 is a view illustrating a wireless airbag apparatus in accordance with an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a wireless airbag apparatus according to a preferred embodiment of the present invention will be described with reference to the accompanying drawings.

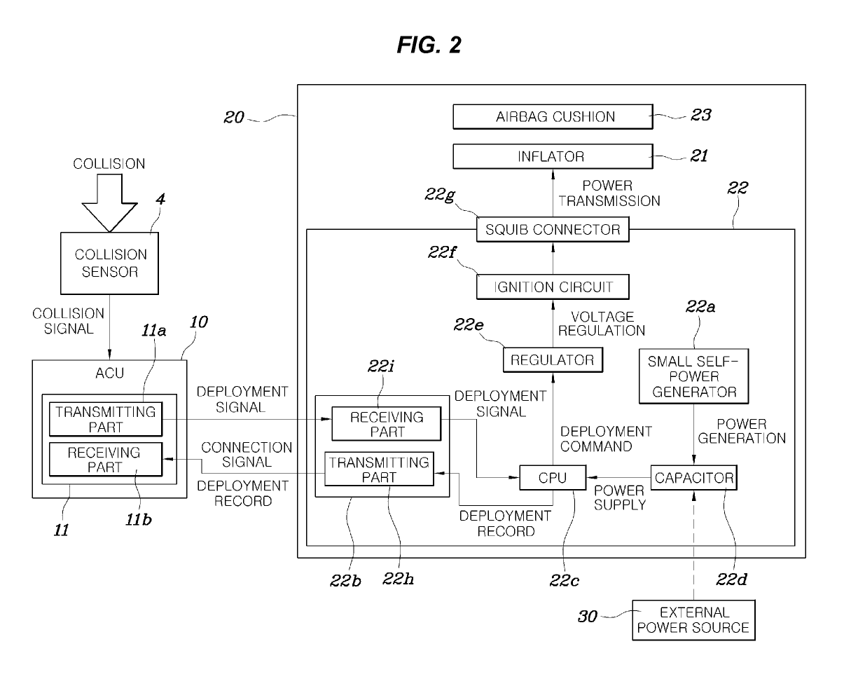

FIG. 2 is a view schematically showing a configuration of a wireless airbag apparatus according to an exemplary embodiment of the present invention. The wireless airbag apparatus according to an exemplary embodiment of the present invention largely includes an airbag control unit (ACU) 10 that has a wireless communication unit 11, and an airbag module 20 that has a power supply circuit 22 to transceive a signal with the wireless communication unit 11 of the ACU 10 and thereby supply operating power to an inflator 21.

The ACU 10 is configured to receive a signal from a collision sensor 4 provided in a vehicle.

Further, the power supply circuit 22 according to an exemplary embodiment of the present invention includes a wireless communication unit 22b, a CPU 22c, a capacitor 22d, a regulator 22e, and an ignition circuit 22f. The wireless communication unit 22b transceives a signal with the wireless communication unit 11 of the ACU 10, and generates a deployment signal for an airbag cushion 23. The CPU 22c generates a deployment command for the airbag cushion 23 in response to the signal of the wireless communication unit 22b. The capacitor 22d accumulates power required to operate the inflator 21 and supplies the power to the CPU 22c. The regulator 22e regulates the voltage required to deploy the airbag cushion 23 in response to a signal of the CPU 22b. The ignition circuit 22f transmits an ignition signal to the inflator 21.

According to an exemplary embodiment, the power accumulated in the capacitor 22d is produced using surplus energy generated from the vehicle by a small self-power generator 22a.

Preferably, the self-power generator 22a is included in the power supply circuit 22 in terms of a package.

Here, the surplus energy is obtained from vibrations, heat, wind, and electric signals of the vehicle. Such surplus energy is used as the power that is required to deploy the airbag cushion 23 by the small self-power generator 22a, which is a device using energy harvesting.

Energy harvesting is a next-generation environmentally friendly technology by which energy is derived from external sources, for example, vibrations, heat, wind, or electric signals and is converted into electricity in order to be used (refer to The Electronic Times dated on Jan. 28, 2011).

According to another embodiment, power accumulated in the capacitor 22d is transmitted from an external power source 30 using wireless power transmission.

The wireless power transmission is energy harvesting technology that transmits electricity from a power source to a desired device without using wires. An electric motor or a transformer using the principle of electromagnetic induction was already being used in the 1800s. Thereafter, there was proposed a method of transmitting electricity by radiating electromagnetic waves such as radio waves or laser beams. Additionally, an electric toothbrush or a wireless razor charged by the principle of electromagnetic induction have been used in daily life (refer to Electronics and Telecommunication Trends vol. 23 No. 6 dated December 2008)

The wireless communication unit 11 of the ACU 10 includes a transmitting part 11a and a receiving part 11b, while the wireless communication unit 22b of the airbag module 20 includes a transmitting part 22h and a receiving part 22i. The transmitting part 11a of the ACU 10 transmits the deployment signal for the airbag cushion 23 to the receiving part 22i of the airbag module 20. The transmitting part 22h of the airbag module 20 transmits a connection signal and a deployment record of the airbag cushion 23 to the receiving part 11b of the ACU 10.

Further, the receiving part 22i of the airbag module 20 transmits the deployment signal for the airbag cushion 23 to the CPU 22c. The CPU 22c transmits the deployment record of the airbag cushion 23 to the transmitting part 22h of the airbag module 20.

Meanwhile, the inflator 21 and the ignition circuit 22f are connected to each other via a squib connector 22g.

As described above, the airbag apparatus according to an exemplary embodiment of the present invention is configured so that the ACU 10 and the airbag module 20 are not connected to each other by a wire, and transceive the signal using wireless communication without using a wire. As such, the airbag apparatus is advantageous because no wire is used, so that it solves the problems that occur during assembly and packaging, prevents the airbag from malfunction, and prevents a warning light from going off due to a contact failure, and allows the airbag apparatus to be used in the same manner regardless of the kind of airbag.

Further, the wireless airbag apparatus according to an exemplary embodiment of the present invention is advantageous because the energy that a vehicle would otherwise waste is converted by the small self-power generator 22a into electricity to be used to deploy an airbag, using energy harvesting technology, and the energy is then utilized, so that additional external power such as a battery is not required, and electricity for deploying an airbag can be semi-permanently produced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A wireless airbag apparatus, comprising:
an airbag control unit (ACU) receiving a sensing signal from a collision sensor and having a first wireless communication unit; and
an airbag module having a second wireless communication unit and a power supply circuit to transceive a signal with the wireless communication unit of the ACU,
wherein the power supply circuit supplies operating power to an inflator in accordance with a deployment signal of the airbag module.

2. The wireless airbag apparatus as set forth in claim 1, wherein the power supply circuit includes:
the second wireless communication unit generating the deployment signal for the inflator to deploy an airbag cushion;
a CPU generating a deployment command for the inflator in response to the deployment signal of the second wireless communication unit;
a capacitor accumulating power required to operate the inflator and to supply the power to the CPU;
a regulator regulating voltage to deploy the airbag cushion in response to the deployment command of the CPU; and
an ignition circuit receiving a regulated voltage of the regulator and transmitting an ignition signal to the inflator.

3. The wireless airbag apparatus as set forth in claim 2, wherein the power accumulated in the capacitor is produced using surplus energy generated from a vehicle by a self-power generator.

4. The wireless airbag apparatus as set forth in claim 3, wherein the self-power generator is included in the power supply circuit.

5. The wireless airbag apparatus as set forth in claim 2, wherein the power accumulated in the capacitor is wirelessly transmitted from an external power source.

6. The wireless airbag apparatus as set forth in claim 2, wherein the inflator and the ignition circuit are connected to each other via a squib connector.

7. The wireless airbag apparatus as set forth in claim 2, wherein the first wireless communication unit of the ACU and the second wireless communication unit of the airbag module include a transmitting part and a receiving part respectively.

8. The wireless airbag apparatus as set forth in claim 7, wherein the transmitting part of the airbag module transmits a connection signal and a deployment record of the airbag cushion to the receiving part of the ACU.
